(19) United States
(12) Patent Application Publication
(10) Pub. No.: US 2007/0194000 A1
(43) Pub. Date: Aug. 23, 2007

(54) Loading device

(76) Inventors: Ottmar Baumeister, Buchold (DE); Marco Brust, Buchold (DE)

Correspondence Address: Muirhead and Saturnelli, LLC, Suite 1001, 200 Friberg Parkway, Westborough, MA, 01581, US

(21) Appl. No.: 11/706,503

(22) Filed: Feb. 15, 2007

(30) Foreign Application Priority Data
Feb. 20, 2006 (DE) 10 2006 008 153.6

(51) Int. Cl. F27D 11/00

(52) U.S. Cl. 219/388

(57) ABSTRACT

A device for loading and unloading an oven or baking chamber includes a movable loading table and a conveyor sheet. The conveyor sheet which forms the upper face of the loading table, runs around at least one reversing edge of the loading table and may be driven. Specifically, the conveyor sheet (also referred to as a belt) may be motor-driven. The device includes a movable cover which may be shifted into a retaining position, in which it prevents items lying on the conveyor sheet from falling off over the reversing edge of the loading table, The loading table has two parallel side pieces and the cover being located in the side pieces of the loading table.

### TECHNICAL FIELD

This application relates to the field of baking systems and, more particularly, to a device for loading and unloading an oven or baking chamber.

### BACKGROUND OF THE INVENTION

Known loading devices include an automatic loading mechanism which is controlled by an electronic control system in such a way that several (for example two to twelve or more) baking chambers of a multi-deck oven are automatically and reliably loaded with pieces of dough and emptied after the preset baking time. The loading mechanism consists of the loading table that can be moved longitudinally, the upper face of which is formed by the conveyor sheet (also referred to as a belt). Pieces of dough are placed on the conveyor sheet and the entire loading table, together with the sheet and the pieces of dough lying on it, is slid into the oven. As the table is withdrawn, the sheet is driven in the opposite direction, causing the pieces of dough to be deposited over the reversing edge of the table onto the baking surface of the baking chamber. The conveyor sheet is generally motor-driven, but may also be operated by hand.

FIG. 1 shows a known loading mechanism. The left half of the illustration schematically shows a multi-deck oven 1. A rigid lifting frame 2, also called a portal, carrying a supporting rack 3 such that the latter may be moved vertically is situated in front of multi-deck oven 1. Portal 2 may be moved laterally relative to oven 1, which means that it is capable of loading several ovens situated side-by-side.

A loading table 4 in the form of a movable slide is situated on supporting rack 3. Loading table 4 can be inserted into and withdrawn from the different baking chambers of multi-deck oven 1. FIG. 1 shows in the lower position, in continuous lines, supporting rack 3 with loading table 4 partially inserted into multi-deck oven 1. In the upper part of lifting frame 2, supporting rack 3 with loading table 4 fully withdrawn from multi-deck oven 1 is shown in dashed lines.

Such a device is described, for example, in EP 0 591 670 B1.

In addition to depositing the pieces of dough in the oven, moveable loading table 4 (slide) is also used for picking up baked goods in the oven in order to remove them. In this process loading table 4 is slid into the baking chamber of the multi-deck oven, the front reversing edge of the loading table, around which the conveyor sheet runs, essentially sliding over the upper surface of the plate in the baking chamber. At the same time the portion of the conveyor sheet located on the upper face of the loading table is pulled rearwards, against the direction of insertion. If the front reversing edge of the loading table comes into contact with a baked item, the conveyor sheet slides under the baked item and pulls the latter from the front reversing edge rearwards onto the loading table. In this way it is ensured that the finished baked goods are placed onto the loading table and not simply pushed by the reversing edge across the baking chamber plate and into the back of the oven.

As the loading table reaches the end of its travel, the reversing edge is located near to the rear wall of the baking chamber. The loading table is then pulled back again, in order to remove the baked goods on it from the baking chamber.

In devices known to date, the problem has been observed that, while the loading table was being pulled back, baked goods could fall over the reversing edge, and remain in the baking chamber. This occurs in particular with small round baked goods such as rolls. If these baked goods remain in the baking chamber, they become overheated and over time will burn. This jeopardizes the quality of all subsequent batches loaded into the oven. Manual removal of baked goods remaining in the baking chamber using an extraction tool is time-consuming and hazardous. In particular if the baked goods remain in one of the upper baking chambers of a multi-deck oven, a ladder is needed so that the baker can work at the level of the baking chamber. Removing the baked goods by means of an extraction tool from the baking chamber, which is often more than 2 meters deep, entails a significant risk of burns.

Publication DE 74 12 622 discloses an oven-clearing device without a conveyor sheet. In this device, a supporting frame, which has a fully closed bottom, is slid into the oven and pulled back out of it, in order to collect baked goods lying in the oven. A swiveling chute or a bar extending across the width of the free collecting edge forms a retaining element that secures the baked goods gathered on the bottom against falling off.

Accordingly, it would be desirable to create a loading device that effectively incorporates a means of securing the baked goods against falling off of a conveyor sheet.

### SUMMARY OF THE INVENTION

According to the system described herein, a device for loading and unloading an oven or baking chamber includes a movable loading table and a conveyor sheet. The conveyor sheet may form the upper face of the loading table, run around at least one reversing edge of the loading table and may be driven. A movable cover in included which may be shifted into a retaining position in which it prevents items lying on the conveyor sheet from falling off over the reversing edge of the loading table. The loading table may have two parallel side pieces, and the cover may be located between the side pieces of the loading table.

According further to the system described herein, a loading and unloading device includes a movable loading table and a conveyor sheet coupled to the loading table. The conveyor sheet may be disposed on at least one edge of the loading table. A retaining element is movable between at least a first position and a second position, at least one of the first and second positions being a retaining position. In the retaining position, the retaining element prevents items on the conveyor sheet from falling over the at least one edge of the loading table. The loading table may include at least two side pieces, and wherein the retaining element moves between the first position and the second position on guides disposed within the side pieces. The retaining element may be a movable cover that extends transversely over a width of the movable loading table. The device may further include a drive that moves the retaining element between the first position and the second position and a coupling component that couples the retaining element with the drive. The drive may be a pneumatic cylinder and the coupling component may be a chain. The drive may be disposed at an opposite end from the at least one edge of the loading table. The device may further include a drive that moves the conveyor sheet.

According further to the system described herein, a method of loading and unloading an oven or baking chamber includes inserting a loading table into the oven or baking chamber and activating movement of a conveyor sheet coupled to the loading table. The conveyor sheet may be disposed over at least one edge of the loading table. A retaining element is moved between at least a first position and a second position, wherein one of the first position and the second position is a retaining position. In the retaining position, the retaining element prevents items on the conveyor sheet from falling over the at least one edge of the loading table. The loading table may includes at least two side pieces, and wherein the movement of the retaining element is guided by guides in the at least side pieces. The movement of the retaining element may be mechanically driven. At least the other of the first position and the second position that is not the retaining position may be a position of the retaining element that allows depositing and removal of the items to and from the conveyor sheet.

The fact that a moving cover is able to be shifted into a retaining position, in which items lying on the conveyor sheet are prevented from falling off, ensures that no baked goods unintentionally remain in the baking chamber or oven. The retaining element is movable so that it may be shifted out of its retaining position, when, during removal from the oven, baked goods are gathered over the reversing edge onto the conveyor sheet or when, upon insertion into the baking chamber, baked goods are deposited over the reversing edge.

The cover may be shifted into the area which is adjacent to the reversing edge of the loading table. In other words, a movable cover is provided which is able to be shifted into the area upstream of and above the reversing edge, in order to prevent baked goods from falling off. The cover may be moved back away from the reversing edge when this area should remain clear in order to remove baked goods from the oven or to deposit them onto the plate of the baking chamber.

In a preferred embodiment, the cover may take the form of a covering strip. The cover, in particular such a covering strip, is located and guided between two side pieces, which are fitted on the side edges of the loading table running in the direction of movement of the same. The covering strip is preferably able to be moved between a first position in the upper area of the side piece, in which it runs parallel to the plane of the loading table, and a second position near to the reversing edge. The second position forms the retaining position, the covering strip in the vicinity of the reversing edge extending essentially perpendicularly with respect to the surface of the loading table.

In the first covering strip position, the covering strip and the side pieces, together with the reversing edge, essentially surround the cross section of the baking chamber in such a way that when items to be baked are deposited or baked goods are collected, the cross section of the baking chamber is not blocked. In the retaining position, the covering strip, starting at the reversing edge, extends over a height Of several centimeters in such a way that baked goods such as rolls are reliably prevented from falling off. At a normal width of the loading table (between, 0.6 m and 2 m and above), such a covering strip with the requisite rigidity may be produced from conventional metals such as aluminum or steel.

In order that the covering strip may be shifted into the upper part of the cross section of the baking chamber when it is not needed, the side pieces may be of essentially the same height as the oven or baking chamber to be loaded or unloaded by the device. If the oven has baking chambers of differing heights, the height of the side piece may be essentially the same height as the lowest chamber, the doors of the,other baking chambers featuring suitable devices to ensure that they are able to be fully opened.

The opposing surfaces of the side pieces are preferably fitted with guides which guide the cover in the forward edge area of the loading table, i.e., in the area above the reversing edge of the loading table. As already stated, the guides may extend from the upper edge of the side pieces to the vicinity of the reversing edge. While the loading table is being slid into the oven in order to gather up baked goods, the cover is located in the area of the upper edge of the side piece and thus in the uppermost part of the cross section of the baking chamber. Once all baked goods have been collected, the cover is shifted to the vicinity of the reversing edge, where it covers the forward edge area of the loading table in a vertical position. This ensures that baked goods lying on the conveyor sheet do not roll off.

Each guide for the cover in either of the side pieces preferably is followed by a receptacle for a coupling component. The coupling component links the cover with a drive. The coupling component may take the form of a pushing and pulling element such as a chain, for example. The drive should be located in the rear part of the loading table, which is not inserted into the oven or baking chamber, or is not inserted very far. This will avoid damage to the drive resulting from the high temperature in the baking chamber or oven. The chain transmits the movement of the drive along the length of the loading table and ensures that, after collection of the baked goods and before withdrawal of the loading table from the baking chamber, the cover is shifted into the retaining position, in order to prevent the baked goods from falling off.

Any form of drive, such as electric motors, drive cylinders, etc., may be used to move the cover. In particular a pneumatic cylinder has proven effective for actuating the chain and the cover connected thereto.

### BRIEF DESCRIPTION OF THE DRAWINGS

Embodiments of the system described herein are described below referring to the attached drawings, in which:

FIG. 1 shows a multi-deck oven with a loading device according to the related art;

FIG. 2 shows a cut-away representation of the device according to the system described herein during collection of baked goods;

FIG. 3 shows the embodiment of FIG. 2 with its cover in the retaining position.

### DETAILED DESCRIPTION OF VARIOUS EMBODIMENTS

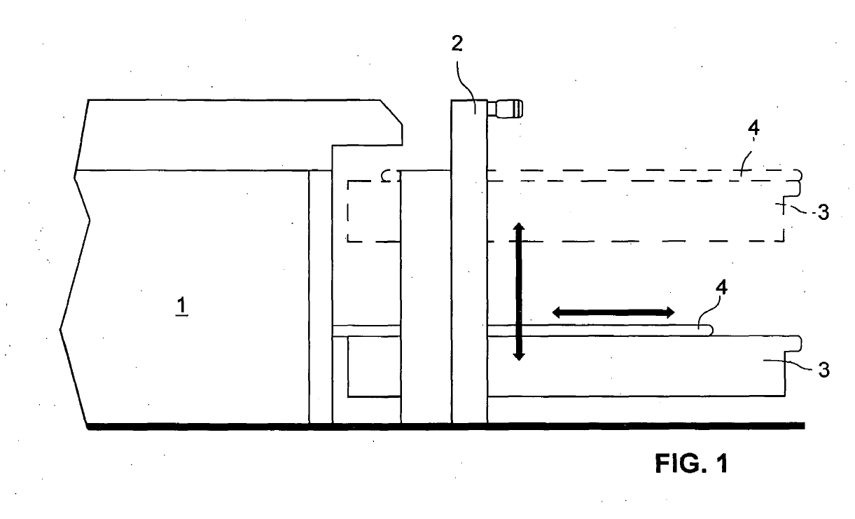

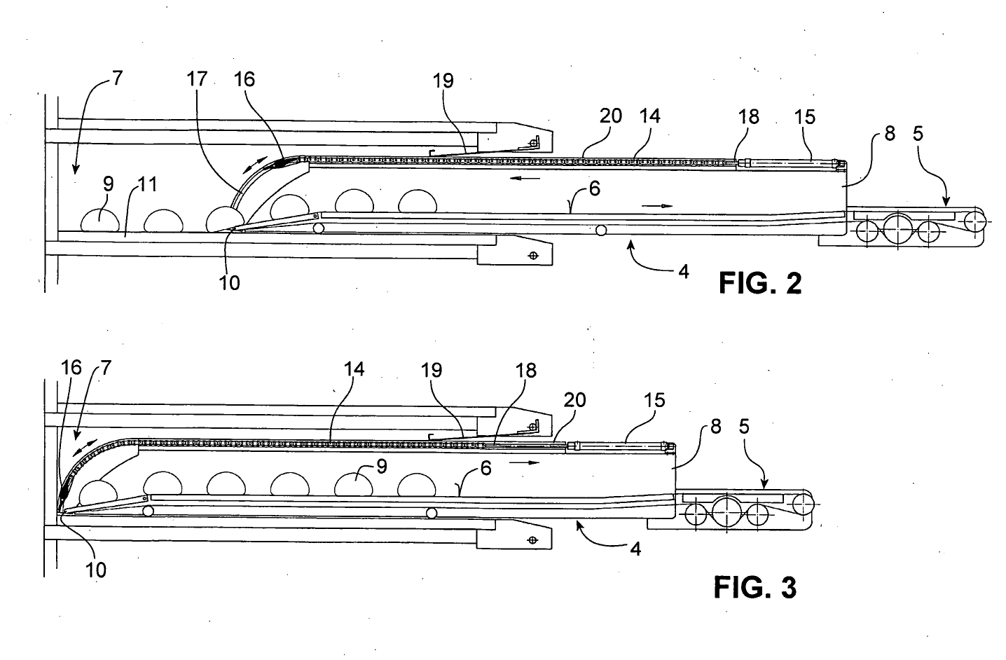

Loading table 4 shown in FIGS. 2 and 3, as can be seen in the schematic representation in FIG. 1 and as is described in greater detail above, is moveably mounted on a supporting rack.

The supporting rack is preferably held by a lifting frame in a vertically adjustable manner, so that it may be moved to the height of a baking chamber of a multi-deck oven. The lifting frame may also be shifted preferably perpendicular to the front face of the multi-deck oven so that several multi-deck ovens situated side-by-side may be loaded by the loading device. FIGS. 2 and 3 show only loading table 4 with one baking chamber 7, but not the lifting frame with the supporting rack.

The embodiment in FIGS. 2 and 3 shows drive 5 for conveyor sheet 6 of loading table 4. Loading table 4 is situated in FIG. 2 halfway into baking chamber 7. Loading table 4 features two side pieces 8, only one of which is shown in each case in the cut-away representation in FIGS. 2 and 3. Side piece 8 serves to open and hold open baking chamber door 19 while loading table 4 is being slid into baking chamber 7.

FIG. 2 shows loading table 4 during the collection of baked goods 9 lying in the baking chamber. During this collection process, front reversing edge 10 of loading table 4 lies essentially flat on plate 11 of the baking chamber. Loading table 4 is inserted in the direction of the upper arrow in FIG. 2 into the baking chamber. At the same time conveyor sheet 6 forming the surface of loading table 4 is pulled back in the opposite direction (lower arrow in FIG. 2) so that it gathers baked goods 9 from baking chamber 7.

Over the major portion of their length, side pieces 8 of loading table 4 carry a profile 20, which forms a hollow receptacle for a pushing and pulling chain. At the rear end of loading table 4, chain 14 is connected to piston rod 18 of a pneumatic cylinder 15. At the front end of loading table 4, chain 14 is connected to a covering strip 16 which extends transversely over the entire width of loading table 4. The width of loading table 4 and thus the length of covering strip 16 are normally between 1 m and 2 m. Covering strip 16 may be made of stainless steel. In the position shown in FIG. 2, covering strip 16 is situated in the area of the upper edge of side piece 8. Covering strip 16 thus barely obstructs the cross section of baking chamber 7. This renders possible the depositing and removal of baked goods, which are distributed across the entire cross section of baking chamber 7.

After loading table 4 has been slid into baking chamber 7 and all baked goods are lying on conveyor sheet 6 of loading table 4, pneumatic cylinder 15 is activated and pushes chain 14 forward in such a way that cover 16, which runs in guide slots 17 in the opposing surfaces of side pieces 8, is moved into the retaining position (see FIG. 3). In the retaining position cover 16 extends upward from reversing edge 10. In this position it is ensured by means of the cover (covering strip 16) that baked goods 9 on the conveyor sheet do not fall over reversing edge 10 back into baking chamber 7.

After loading table 4 has been withdrawn from baking chamber 7, piston rod 18 is withdrawn back into pneumatic cylinder 15 in such a way that covering strip 16 is moved into the position shown in FIG. 2 and leaves the front cross section of the loading table clear.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A device for loading and unloading an oven or baking chamber, comprising:
a movable loading table;
a conveyor sheet which forms an upper face of the loading table, runs around at least one reversing edge of the loading table, and is driven; and
a movable cover which, in at least a first position, is shifted into a retaining position, wherein the movable cover prevents items lying on the conveyor sheet from falling off over the reversing edge of the loading table, wherein the loading table includes two parallel side pieces, and wherein the cover is located in the side pieces of the loading table.

2. The device as recited in claim 1, wherein the cover is a covering strip.

3. The device as recited in claim 1, wherein the height of the side pieces is substantially the same as the height of the oven or baking chamber to be loaded or unloaded by the device.

4. The device as recited in claim 1, wherein the opposing surfaces of the side pieces include guides for the cover in the area adjacent to the reversing edge of the loading table, the guides extending from the upper edge of the side pieces to the proximity of the reversing edge.

5. The device as recited in claim 4, wherein a receptacle for a coupling element is incorporated into each guide slot for the cover in a side piece, the coupling element connecting the cover with a drive.

6. The device as recited in claim 5, wherein the coupling element is a chain.

7. The device as recited in claim 5, wherein the drive is situated at the end of the loading table opposite the reversing edge.

8. The device as recited in claim 7, wherein the drive is a drive cylinder.

9. A loading and unloading device, comprising:
a movable loading table;
a conveyor sheet coupled to the loading table, wherein the conveyor sheet is disposed on at least one edge of the loading table; and
a retaining element which is movable between at least a first position and a second position, at least one of the first and second positions being a retaining position, wherein, in the retaining position, the retaining element prevents items on the conveyor sheet from falling over the at least one edge of the loading table.

10. The device as recited in claim 9, wherein the loading table includes at least two side pieces and wherein the retaining element moves between the first position and the second position on guides disposed within the side pieces.

11. The device as recited in claim 9, wherein the retaining element is a movable cover that extends transversely over a width of the movable loading table.

12. The device as recited claim 9, further comprising:
a drive that moves the retaining element between the first position and the second position.

13. The device as recited in. Claim 12, further comprising:
a coupling component that couples the retaining element with the drive.

14. The device as recited in claim 13, wherein the drive is a pneumatic cylinder and the coupling component is a chain.

15. The device as recited in claim 12, wherein the drive is disposed at an opposite end from the at least one edge of the loading table.

16. The device as recited in claim 9, further comprising:
a drive that moves the conveyor sheet.

17. A method of loading and unloading an oven or baking chamber, comprising:
inserting a loading table into the oven or baking chamber;
activating movement of a conveyor sheet coupled to the loading table, wherein the conveyor sheet is disposed over at least one edge of the loading table; and
moving a retaining element between at least a first position and a second position, wherein one of the first position and the second position is a retaining position, wherein, in the retaining position, the retaining element prevents items on the conveyor sheet from falling over the at least one edge of the loading table.

18. The method as recited in claim 17, wherein the loading table includes at least two side pieces, and wherein the movement of the retaining element is guided by guides in the at least side pieces.

19. The method as recited in claim 17, wherein the movement of the retaining element is mechanically driven.

20. The method as recited in claim 17, wherein at least the other of the first position and the second position that is not the retaining position is a position of the retaining element that allows depositing and removal of the items to and from the conveyor sheet.
